(19) United States
(12) Patent Application Publication
(10) Pub. No.: US 2025/0147777 A1
(43) Pub. Date: May 8, 2025

(54) TECHNIQUES FOR UPDATING GRAPHICAL USER INTERFACES

(71) Applicant: GE Precision Healthcare LLC, Waukesha, WI (US)

(72) Inventor: Sélim Zenagui, Chateaufort (FR)

(21) Appl. No.: 18/500,234

(22) Filed: Nov. 2, 2023

(51) Int. Cl. G06F 9/451; G06F 3/04845

(52) U.S. Cl. CPC G06F 9/451; G06F 3/04845

(57) ABSTRACT

A processor-implemented method includes receiving user input from one or more user input devices, the user input corresponding to a selected element of a displayed graphical user interface having one or more software hooks to functionality provided by an undisplayed interface. The processor-implemented method also includes determining one or more corresponding target functions of the undisplayed interface based on the selected element, executing the one or more corresponding target functions via the one or more software hooks, and displaying one or more changes to the displayed graphical user interface based on the execution of the one or more corresponding target functions.

### TECHNICAL FIELD

The subject matter disclosed herein relates to medical imaging devices, and more specifically, to techniques for updating graphical user interfaces for medical devices so as to change or improve the interface or appearance associated with a pre-existing or outdated interface.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

A medical imaging device may be used for imaging anatomic targets, such as organs and soft tissues in a human body, as well as non-human targets, such as packages or baggage, manufactured items undergoing quality control, and so forth. For example, a medical imaging device may be used for applications such as ultrasound/acoustic sensing, non-destructive evaluation (NDE), ultrasound therapy (e.g., High Intensity Focused Ultrasound (HIFU)), etc., in addition to ultrasound imaging of humans, animals, etc.

The imaging device, such as a medical imaging device, may include a user interface (UI) to facilitate implementation or configuration of an imaging protocol or session, viewing of real-time or previously acquired image data, and/or accurate and efficient diagnoses and treatment of a patient. The UI may present, for example, various imaging modalities (ultrasound, X-ray), patient information, and control options to a clinician. Additionally, the UI may include various graphical components, including layouts, windows, buttons, icons, and menus that may facilitate navigation of the UI. Over time, and as technology changes, a UI design, layout, or selectable option feature set may become outdated or otherwise unsuited or different from other types of interfaces utilized by a clinician. However, updates to such an existing imaging system may be challenging to implement because of limitations of existing software functionalities, costs associated with implementation, and so on.

### BRIEF DESCRIPTION

The disclosed embodiments are not intended to limit the scope of the claimed subject matter, but rather these embodiments are intended only to provide a brief summary of possible embodiments. Indeed, the disclosure may encompass a variety of forms that may be similar to or different from the embodiments set forth below.

In one embodiment, a processor-implemented method includes receiving user input from one or more user input devices, the user input corresponding to a selected element of a displayed graphical user interface having one or more software hooks to functionality provided by an undisplayed interface. The processor-implemented method also includes determining one or more corresponding target functions of the undisplayed interface based on the selected element, executing the one or more corresponding target functions via the one or more software hooks, and displaying one or more changes to the displayed graphical user interface based on the execution of the one or more corresponding target functions.

In another embodiment, a computer-readable medium includes processor-executable code that when executed by a processor, causes the processor to receive user input from one or more user input devices, the user input corresponding to a selected element of a displayed graphical user interface having one or more software hooks to functionality provided by an undisplayed interface. The computer readable medium also includes processor-executable code that when executed by the processor, causes the processor to determine one or more corresponding target functions of the undisplayed interface based on the selected element, execute the one or more corresponding target functions via the one or more software hooks, and display one or more changes to the displayed graphical user interface based on the execution of the one or more corresponding target functions.

In yet another embodiment, a system includes a first computing device configured to display a graphical user interface, receive user input from one or more user input devices, the user input corresponding to a selected element of the displayed graphical user interface having one or more software hooks to functionality provided by an undisplayed interface, and transmit an indication of the selected element. The system also includes a second computing device configured to receive the indication of the selected element, determine one or more corresponding target functions of the undisplayed interface based on the selected element, instruct a third computing device to execute the one or more corresponding target functions via the one or more software hooks, receive an output associated with the execution of the one or more corresponding target functions, and instruct the first computing device to change one or more elements of the displayed graphical user interface based on the output.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a pictorial representation of an imaging system, such as a CT imaging system, in accordance with aspects of the present disclosure;

FIG. 2 is a block diagram of the imaging system in FIG. 1, in accordance with aspects of the present disclosure;

FIG. 3 a block diagram of an updated graphical user interface system, in accordance with embodiments of the present disclosure;

FIG. 4 is an illustration of an updated graphical user interface for a medical imaging device of the imaging system of FIG. 1, in accordance with embodiments of the present disclosure;

FIG. 5 is a block diagram illustrating communications between a web browser and a target application of an updated graphical user interface system, in accordance with embodiments of the present disclosure;

FIG. 6 is a block diagram illustrating communications between components of an updated graphical user interface system using a server, in accordance with embodiments of the present disclosure;

FIG. 7 is a block diagram illustrating communications between multiple web browsers, in accordance with embodiments of the present disclosure;

FIG. 8 is a flowchart of a method for implementing an updated graphical user interface, in accordance with embodiments of the present disclosure;

FIG. 9 is a flowchart of a method for launching and updating an updated graphical user interface, in accordance with embodiments of the present disclosure; and

FIG. 10 is a diagram of a client-server architecture for medical image processing and display, in accordance with embodiments of the present technique.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Any examples or illustrations given herein are not to be regarded in as restrictions on, limits to, or express definitions of, any term or terms with which they are utilized. Instead, these examples or illustrations are to be regarded as being described with respect to various particular embodiments and as illustrative only. Those of ordinary skill in the art will appreciate that any term or terms with which these examples or illustrations are utilized will encompass other embodiments that may or may not be given therewith or elsewhere in the specification and all such embodiments are intended to be included within the scope of that term or terms. Language designating such non-limiting examples and illustrations includes, but is not limited to: “for example,” “for instance,” “such as,” “e.g.,” “including,” “in certain embodiments,” “in some embodiments,” and “in one (an) embodiment.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Medical imaging devices have been used for decades to non-invasively acquire image data of internal structures or physiological processes of a subject, allowing appropriate medical diagnoses to be made and care to be applied without injury to the subject. Examples of such medical imaging technologies include X-ray radiography, computed tomography (CT), magnetic resonance imaging (MRI), positron emission tomography (PET), single photon emission computed tomography (SPECT), mammography, ultrasound, and so forth. Traditionally, such imagery may be evaluated (i.e., read) by trained clinicians, such as radiologists, and advances in medical imaging technology have allowed such imagery to be acquired, process, accessed, and viewed electronically via graphical user interfaces.

A graphical user interface (GUI) for a medical imaging device may provide several benefits to a clinician, and may thus facilitate improved care for a patient. A graphical user interface may provide ease-of-use benefits, allowing clinicians to control a medical imaging device through buttons, sliders, and other visual elements that are straight-forward to interpret and easy to manipulate or otherwise use. The clinician may, for example, manipulate or otherwise control imaging parameters such as default or pre-set imaging protocols, contrast levels, and exposure settings to tailor an imaging procedure to a specific condition of the patient or to a body-type of the patient. Additionally, the graphical user interface may provide real-time visualization during an imaging procedure, such that the clinician can make immediate (i.e., on-the-fly) adjustments as needed. The graphical user interface may also allow a clinician to edit or annotate a medical image to, for example, highlight areas of interest in the image once acquired. Further, the graphical user interface may integrate and display patient information, such as data from an electronic medical record, and may present the patient information along with a medical image, during an image acquisition procedure, or during an image review process.

The lifespan of an imaging system may be many years, or even decades, due to various factors. Such factors may include, but are not limited to the cost or capital investment in the imaging system, the training invested into use of such a system, the actual physical installation and footprint of such an imaging system, and correspondingly, the facility modifications already made to install the imaging system or that might be required to replace such a system. As a result, a serviceable and useful imaging system may be in service for many years. While such an imaging system may still have productive lifespan, in practice certain aspects related to use of the imaging system, such as the graphical user interface or other user interface, may become dated and out of conformance with more modern interface. By way of example, interface elements for an older imaging system may utilize non-optimal layout of screen elements, such as size, placement, and/or type of selectable controls provided to the user. Similarly, placement, sizing, and/or manipulation of image display areas may be non-optimal in view of current display or viewing technologies or conventions. In addition, current interface technologies may employ dynamic previewing or other real-time interaction elements not present in older interfaces.

With the preceding in mind, updates to medical imaging graphical user interface may be desired to improve aesthetics, accessibility, visibility, or clarity, or to otherwise conform a given imaging system graphical user interface to modern standards or design practices. However, these updates may prove technically challenging. For example, an updated graphical user interface may be required to integrate with existing medical imaging functionalities, applications, modalities, device control functions, and so on, while avoiding disruptions to existing systems and to the workflow of clinicians. The updated graphical user interface may also need to work seamlessly with various imaging devices, display devices and communication protocols. Additionally, the updated graphical user interface may need to be thoroughly tested for performance issues such that it meets standards of clinicians, regulatory bodies, and the like. Thus, using traditional methods to update a medical imaging graphical user interface may be complex, and may prove resource demanding in terms of money, time, and personnel.

Provided herein are techniques for updating a graphical user interface such as a graphical user interface utilized by a medical imaging system, while maintaining an underlying application process using interactive hooking and masking techniques. As used herein, the term “updated” as it pertains to a user interface, such as a graphical user interface, may be understood to mean a version different in appearance, presentation, or aesthetics that provides functionalities that may be the same as, or mapped to, pre-existing functionalities of an existing or prior interface, which may be a graphical user interface or other interface. As discussed herein, such an updated interface may be presented or displayed in place of the existing or prior interface. However, the existing or prior interface continues to be executed in the background or in some other manner not visible or displayed to the user such that the functionality of the existing or prior interface is interacted with via the updated graphical user interface.

The disclosed techniques may include overlaying an updated user interface upon a target user interface (e.g., an existing user interface), such that the updated user interface seamlessly accesses target functions of a target application (e.g., an existing application). The updated user interface may access the target functions through hooking techniques. As used herein, the term “hook” may be understood to mean a software component that handles intercepted function calls, software events, and the like. The hooking techniques described herein may include, for example, intercepting user inputs to the updated user interface by modifying executable sources or inserting event hooks at a runtime of an operating system. An intercepted user input may be mapped to a target function via, for example, a server query, and the target functions may then be executed. Finally, an output of the executed target function may affect an appearance change in the updated user interface. As such, the updated user interface may access and execute existing functions of an existing application, and the existing functions may produce changes in the updated user interface.

The updated user interface may include or be implemented as a multiplatform webpage, and may thus be accessed across various mobile, desktop or web-based operating systems. Additionally or alternatively, the updated user interface may be contained locally, and may include dedicated local storage media, processing capabilities, memory, and so on. As mentioned herein, an updated user interface may be described as a mask, a new user interface, a web page, or a thick client, as examples. Communications between the updated user interface, the target user interface (i.e., the original user interface or, more generally, the user interface that is to be updated), the target application, and the target functions may be facilitated by a server, such as a web server. For instance, a web server may respond to requests from a client component, such as a web browser, and may manage functionalities of a web page, such as storing, processing, and providing the web page to a user. The server may, for example, receive inputs from the updated user interface, such as indications of a user input (e.g., mouse input) and/or requests for button feedback. In response to receiving an input, the server may map the input to a corresponding target function of the target application via a hook. As such, the hook may simulate the initiation of the corresponding target function, such as the selection (e.g., button press) of a visual element on the target user interface.

Upon execution of the corresponding target function, the target application may send an output (e.g. button feedback) of the corresponding target function to the server. The server may then cause the updated user interface to reflect the output, such as by updating a visual element of the multiplatform webpage of the updated user interface. Thus, the corresponding target function may affect a change of the updated user interface via the server. However, the change in the updated user interface may present different aesthetics than those presented by the target (e.g., original) user interface in response to the output, may change different visual elements, and so on. The above process may be described herein as the updated user interface “masking” (e.g., being a “mask” of,) the target user interface, which may in certain embodiments be undisplayed (i.e., not displayed) to the user.

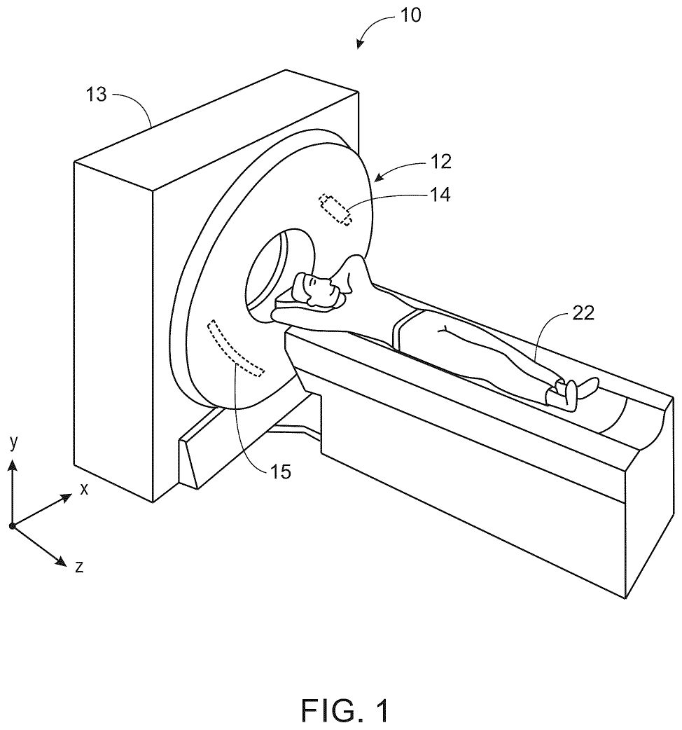

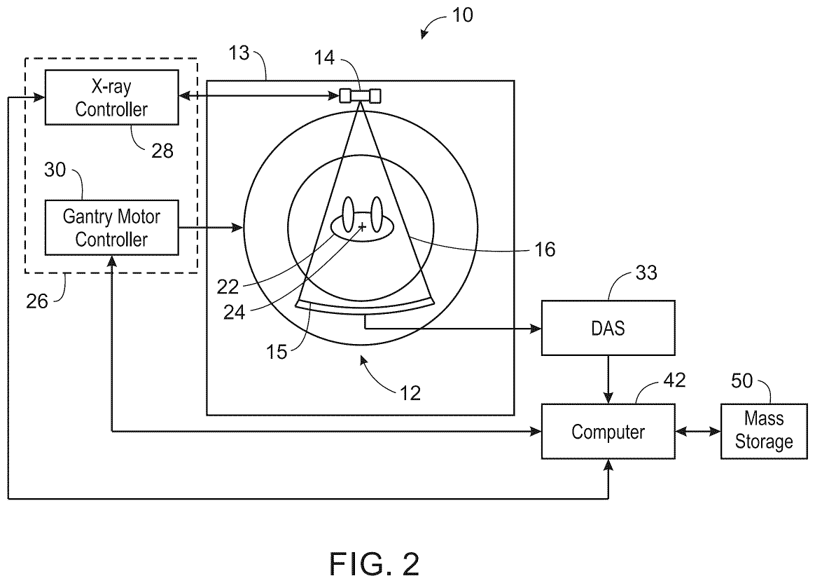

With the preceding in mind and referring to FIGS. 1 and 2, a CT imaging system 10 is shown, by way of example. As may be appreciated, the CT imaging system 10 disclosed and described with respect to FIGS. 1 and 2 merely provides a real-world example of the one type of device that may be present in a health care environment and that may generate complex data, e.g., volumetric image data of a living subject, that may be processed and displayed by a graphical user interface for a clinician. Similarly, such a graphical user interface, as described herein, may be used to parameterize and operate such an imaging system of comparable device, such as to perform scans or other device specific tasks. As may be appreciated, in a hospital or clinical context, numerous types of such electronic devices (e.g., imaging devices, patient monitors, diagnostic equipment, therapeutic equipment, and so forth) may be present and may each generate data or outputs that may be suitable for processing and displaying via a graphical user interface and/or may be operated or configured by such a graphical user interface. With this in mind, FIGS. 1 and 2 describe one such system to illustrate both a real-world example of a possible system operated using such a graphical user interface in a specialized environment (such as an environment where system and interface updates or replacement are infrequent) and the complexity that may be involved in such a system and its outputs that distinguishes such medical-type systems from what might be found in an office or other non-medical context.

With this in mind, and turning to the figures, the CT imaging system 10 (e.g., CT scanner) includes a gantry 12 having a housing 13 (e.g., gantry housing) and a rotating component and a stationary component. By way of example, the gantry 12 has an X-ray source 14 that projects a beam of X-rays 16 toward an X-ray detector assembly or X-ray detector array 15 (e.g., having a plurality of detector modules) on the opposite side of the gantry 12. The X-ray detector assembly 15 is coupled to data acquisition systems (DAS) 33.

The plurality of detector modules of the X-ray detector assembly 15 detect the projected X-rays that pass through a patient or subject 22, and DAS 33 converts the data to digital signals for subsequent processing. During a scan to acquire X-ray projection data, gantry 12 and the components mounted thereon rotate about a center of rotation 24 (e.g., isocenter) so as to allow volumetric imaging. Rotation of gantry 12 and the operation of X-ray source 14 are governed by a control mechanism 26. Control mechanism 26 includes an X-ray controller 28 that provides power and timing signals to the X-ray source 14 and a gantry motor controller 30 that controls the rotational speed and position of gantry 12.

A computer 42 (separate from or a part of the CT imaging system 10) may perform data correction unit and image reconstruction. By way of example, the computer 42 may receive sampled and digitized X-ray data from DAS 33 and perform high-speed image reconstruction. The reconstructed image may be stored in a mass storage device 50 and/or displayed to a clinician via a graphical user interface. With respect to the presently described techniques, an updated graphical user interface may be implemented on or by and displayed by the computer 42 to allow user operation of the CT imaging system 10 and/or review, annotation, and manipulation of images generated using the CT imaging system 10 (or comparable system or device).

As may be appreciated, the imaging system 10 or a similar imaging system may be complex in nature and may benefit from ease-of-use benefits that allow clinicians to control a medical imaging device through buttons, sliders, and other visual elements that are straight-forward to interpret and easy to manipulate or otherwise use. These benefits may be provided by an updated medical imaging graphical user interface that allows a clinician to interface with the imaging system 10 in a manner that is more streamlined or efficient than what was possible using prior or existing versions of an interface. Additionally, as noted herein, updates to medical imaging graphical user interfaces may be desired to improve aesthetics, accessibility, visibility, or clarity, or to otherwise conform a given imaging system graphical user interface to modern standards or design practices. However, the complexity of imaging systems such as the imaging system 10 may present challenges in updating a graphical user interface associated with the imaging system 10.

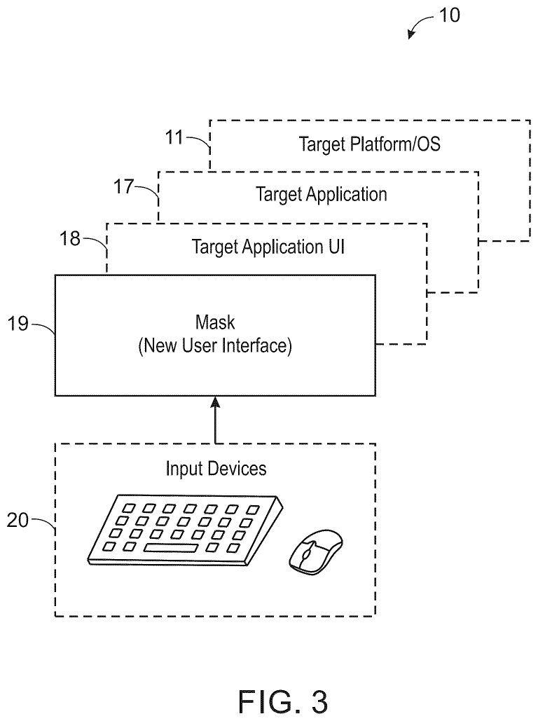

With the foregoing in mind, FIG. 3 is a block diagram of a system 10 including an updated user interface 19 that masks a target user interface 18, which may, in some embodiments not be displayed (i.e., be undisplayed) even if executing. The target user interface 18 may be included as part of, or used in conjunction with, a target application 17, and the target application 17 may be managed by a target platform/operating system (OS) 11. Additionally, the updated user interface 19 may accept inputs from a user (e.g., a clinician) via input devices 20.

The target platform/OS 11 may include an operating system associated with, for example, a medical imaging system. The target platform/OS 11 may include a proprietary operating system developed to manage medical imaging applications, or may include a commercially available (e.g., general purpose) operating system that runs the medical imaging applications. In any case, the target platform/OS 11 may manage multiple software or hardware applications including the target application 17. As used herein, managing the target application 17 may include handling storage, memory, processing, input/output (I/O), and other tasks of the target application 17. In addition to the target user interface 18, the target application 17 may include other core functions, such as controlling a medical imaging device, processing or displaying medical images, accessing medical records, and so forth, as an example.

As described herein, the updated user interface 19 may include or be implemented as a web page, and the web page may be compatible across multiple platforms, such as various web browsers or operating systems. Additionally, in some embodiments, visual elements of the web page may be rearranged or reorganized such that they may be properly displayed on multiple devices. For example, the visual elements of the web page may be repositioned based on screen size, resolution, and other suitable properties such that the updated user interface 19 may be compatible with various mobile devices, monitors, or other displays. The web page may include or be part of a Hypertext Markup Language (HTML) file, and the HTML file may define structure and content characteristics of the web page and/or the updated user interface 19. For example, visual elements of the updated user interface 19 may include HTML elements that define characteristics of the visual elements. Additionally, the web page may include or be part of a Cascade Styling Sheets (CSS) file that may define visual effects of the web page and/or updated user interface, such as layouts, colors, and so on. In any case, at least a portion of processing functions associated with the web page may be completed by a server, while the web page may reflect instructions (e.g., display instructions from the server). As such, the web page may be herein described as a “thin client”.

In other embodiments, the updated user interface 19 may include a thick client, and the thick client may be installed on a client device, such as a workstation (e.g., laptop or desktop computer) or console of a medical imaging system. As used herein, the term “thick client” may be understood to mean a device capable of processing, storing, and managing data independent of a server or, alternatively, in conjunction with communications with a server. The thick client may complete most or all of the processing functions associated with updates to the user interface 19, and may be managed by, for example, an operating system associated with the medical imaging system. As such, communications with a server for interface updates may not be necessary, and a server may not be needed to facilitate communications between the updated user interface 19, the target user interface 18, the target application 17, and the target platform/OS 11.

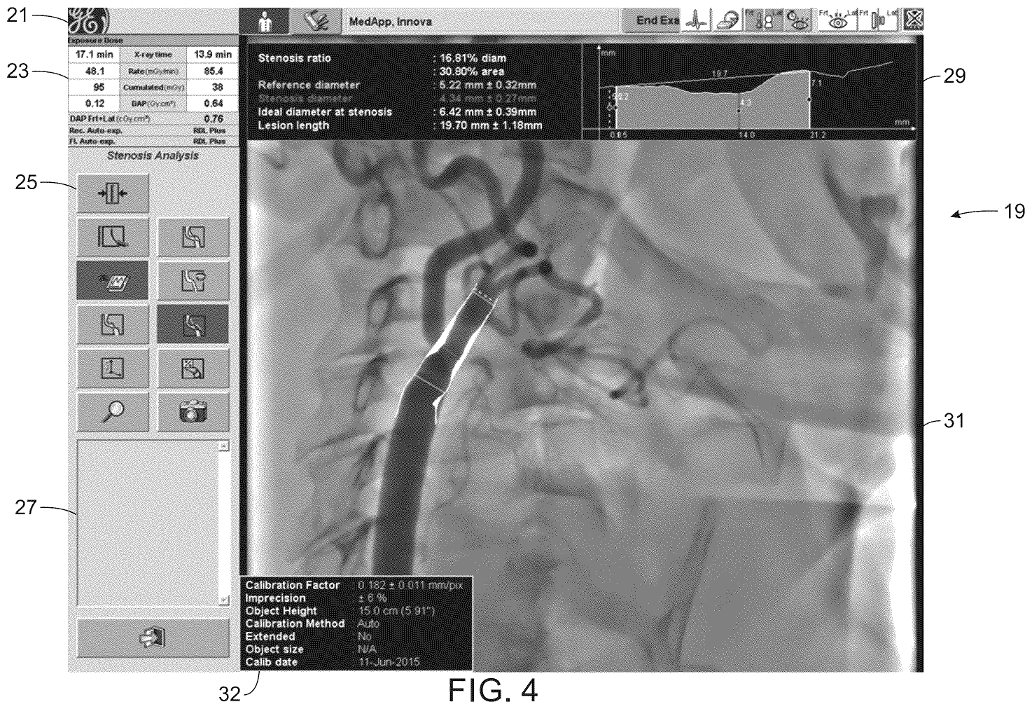

FIG. 4 is an illustration of an example updated user interface 19 for use with a medical imaging device. The updated user interface 19 may include components such as aesthetics 21 (e.g., logos, slogans, and so forth), medical imaging device information 23, patient diagnostic information 29, buttons 25, a scroll window 27, calibration information 32, and a medical image 31. As discussed herein, the components of the updated user interface 19 may provide improved aesthetics, accessibility, visibility, or clarity over components of a previously implemented or original user interface, such as the target user interface of FIG. 3, which may not be displayed to the user in favor of displaying the updated user interface 19. For example, the medical imaging device information 22 may provide additional information of the medical imaging device, the patient diagnostic information 29 may display more interpretable statistics associated with a patient, the buttons 25 may include symbols that are more intuitive, differently sized or actuated, and so on. These improvements may be implemented via, for example, CSS files or HTML files associated with the updated user interface 19.

User inputs received at the updated user interface may be intercepted and mapped to target functions of a target application (e.g., the target application 17). The user inputs may include, for example, an indication of a button press (e.g., from a mouse) at a cursor location corresponding to a selected button of the buttons 25. The selected button may be mapped to a corresponding target function, such that when the button is selected via the user input, the target function is executed. Further, the execution of the target function may cause an update to the updated user interface 19, such as different information being displayed as part of the medical imaging device information 22. Additionally or alternatively, the execution of the target function may cause the medical imaging device to perform a function, such as causing an X-ray machine to alter an amount of radiation output, to initiate a scan, to terminate a scan, to recalibrate a detector array, and so forth.

Further, a selected button of the buttons 25 may be mapped to multiple (e.g., a set of) corresponding target functions, and user input at the selected button may cause execution of the multiple corresponding target functions. The multiple corresponding target functions may be associated with, for example, a clinical scenario, and execution of the multiple corresponding target functions via the updated graphical user interface may be useful for education or demonstration purposes in a clinical setting. By way of example, a clinician may want to present advanced X-ray post processing functions to an audience (e.g., a class of interns). Using the target user interface, the clinician may have to interface with the target user interface multiple times to execute the target functions necessary to prepare for post-processing. For example, an exam may need to be initiated for the X-ray system, clinical protocols may need to be selected, frame rates and dosage levels may need to be chosen, and so on, and each target function may be mapped to separate buttons on the target user interface. On the updated user interface, however, these multiple corresponding target functions may be mapped to a particular button (e.g., a “scenario button”) that, upon user input, accesses the necessary target functions. As such, the clinician may provide user input at the particular button to execute all necessary functions, obviating the need for complex interfacing with the X-ray system to prepare for the demonstration.

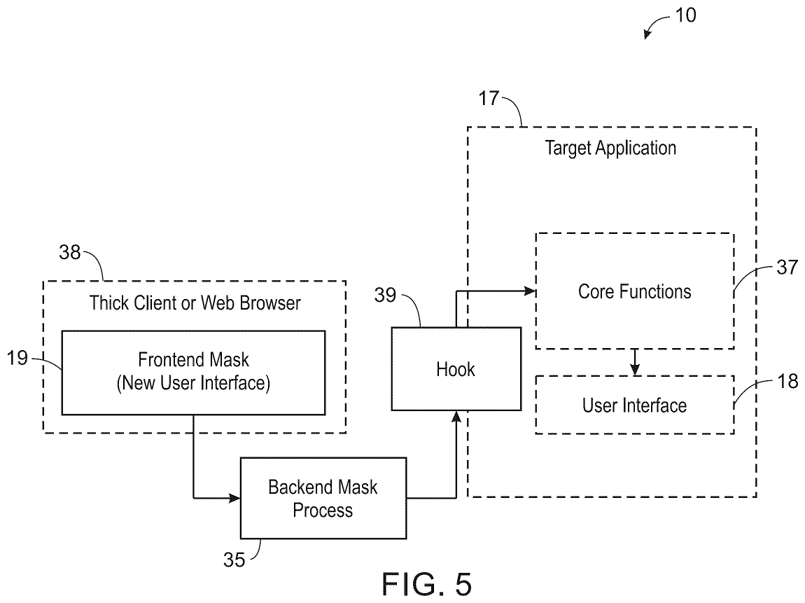

FIG. 5 is a block diagram of the system 10, in which the updated user interface 19 accesses target functions 37 via a backend mask process 35 and a hook 39. As described herein, the updated user interface 19 may be part of, or used in conjunction with, a web page, and the updated user interface 19 may be accessed via a thick client or web browser 38. The target application 17 may include target functions 37 and the target user interface 18. The target application 17 may be a previously implemented application (e.g., legacy application) associated with a medical imaging device, and the target user interface may be a previously implemented or original user interface (e.g., legacy user interface) used to display data of and/or control the medical imaging device. The target user interface 18 may, for example, be used to execute target functions 37. Additionally or alternatively, the target functions may cause changes in components of the target user interface 18, such as graphs, data, and numerical information of the medical information device or a patient.

The updated user interface 19 and/or the thick client or web browser 38 may cause (e.g., trigger) a backend mask process 35 that provides access to the target functions 37 and/or the target user interface 18 via the hook 39. In some examples, the backend mask process 35 and/or the hook 39 may be managed or facilitated by one or more dynamic-link libraries (DLLs) capable of storing a collection of one or more functions. As such, a DLL may store the target functions 37 to be accessed by the updated user interface 19 and/or the web browser 38. In other examples, similar or corresponding approaches, such as debugger-aided techniques, are envisioned. The backend mask process 35 may include an input event (e.g., a click event, an onclick event, or an ontouch event) causing a query to be sent to a server when user input is received at the updated user interface 19. The input event may correspond to a click, tap, touch, or other user input from, for instance, the user input devices 20 of FIG. 3. For example, a click event may call a function when a button (e.g., HTML element) on the updated user interface 19 is clicked, and the function may query the server with an indication of which button was clicked as input. In response to the query, the server and/or the hook 39 may map the button click to a corresponding target function of the target functions 37 via interception by the hook 39. As such, the hook 39 may intercept the user input at the updated user interface 19 and cause the execution of the corresponding target function. In other embodiments, the hook may intercept the user input and cause a simulated user input at the target user interface 18. For example, the server and/or the hook 39 may map a user input at the updated user interface 19 to a corresponding HTML element of the target user interface 18. As such, the target application 17 may execute one or more target functions associated with the corresponding HTML element.

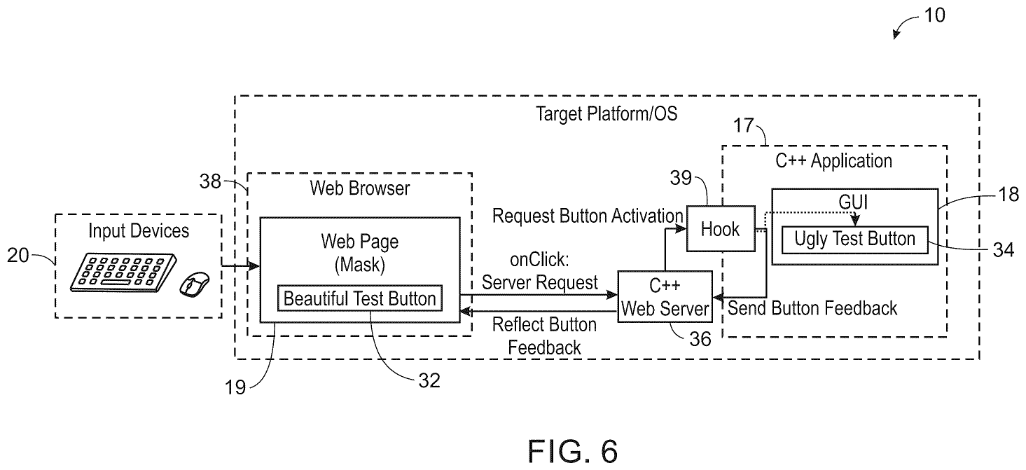

FIG. 6 is a block diagram illustrating communication pathways between components of the system 10, including the updated user interface 19, the server 36, and the target user interface 18. The updated user interface 19 may receive user input from input devices 20, and the user input may correspond to a click event or other input event associated with the updated button 32. The click event may cause the server 36 to be queried. In response, the server 36 may send a request to activate a corresponding button 34 of the target user interface 18, which may be part of the target application 17, via the hook 39. Activating a button may include a simulated press of the corresponding button 34 that causes corresponding target functions to be executed, as described herein.

As illustrated, the updated user interface 19 may include a web page, and may be accessed by a user via, for example, a web browser 38. As is also illustrated, the web browser 38 and the target application 17 may share a target platform/OS 11. For example, the web browser 38 may be managed by the same operating system that the target application 17 is managed by. Additionally or alternatively, the updated user interface 19 may include or be accessed by a thick client, as described herein.

When the corresponding button 34 is activated and/or the corresponding target functions are executed, target button feedback may be routed to the updated user interface 19 via the server 36. For example, the target function may cause a change in a visual element of the target user interface 18 and/or the target application 19. The target button feedback may be sent to the server 36, and the server 36 may then map the button feedback to reflected feedback in the updated user interface 19. The reflected feedback may then be sent to, and displayed at, the updated user interface 19. The reflected feedback may include, for example, a visual change in an HTML element of the updated user interface 19.

The updated button 34 may have updated aesthetics, display characteristics, viewing pane and/or control layout, and so on that may provide a more modern or intuitive experience for a user. Additionally, the corresponding button 34 and the updated button 32 may correspond to similar portions of the updated user interface 19 and the target user interface 18, respectively, and the target button feedback and the reflected feedback may cause similar changes in the updated user interface 19 and the target user interface 18. The target button feedback and the reflected feedback may cause similar control functions of, for example, a medical imaging device. As such, users of the updated user interface 19 who are familiar with the target user interface 18 may maintain some familiarity when using the updated user interface 19. Further, by maintaining the functionality of the corresponding button 34, the target user interface 18, and the target functions of the target application 17, the need for implementation of new functions may be obviated, and thus interface updates may be less costly.

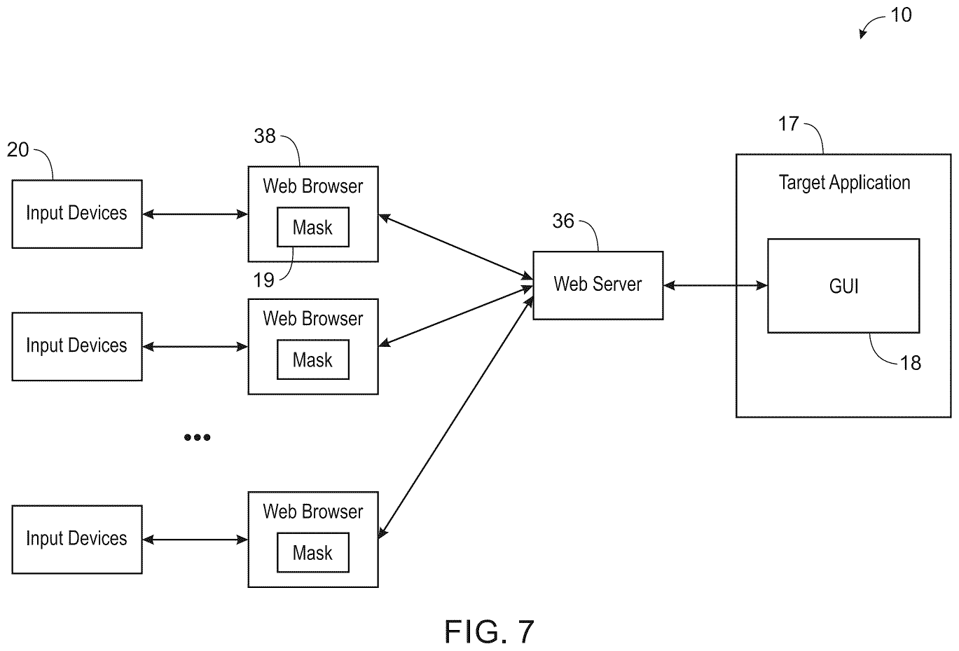

While FIG. 6 shows one web browser 38 and updated user interface 19, in some embodiments, multiple web browsers 38 and multiple updated user interfaces 19 may access the target application 17 via the server 36. FIG. 7 illustrates the system 10, in which multiple web browsers 38 query the server 36. Each web browser 38 includes an updated user interface 19, and each web browser 38 may receive input from input devices 20. Each input may correspond to an input event, such as a click event, and each click event may cause the server 36 to be queried. In response, the server 36 may send request to activate a corresponding button of the target user interface 18, which may be part of the target application 17, via a hook, as described herein. Activating a button may include a simulated press of a corresponding button that causes corresponding target functions to be executed, and the target functions may cause a change in one or more of the updated user interfaces 19. As such, the target application 17 and the target user interface 18 may include target functions that may be accessed by the multiple web browsers 38, and the server may manage communications between each web browser 38 and the target application 17.

Each web browser 38 and the server 36 may communicate using suitable network communication techniques, such as the Hypertext Transfer Protocol (HTTP), Transmission Control Protocol (TCP), Internet Protocol (IP), Wi-Fi, Bluetooth, Near Field Communication (NFC), and the like. As such, each web browser 38 may send queries (e.g., HTTP requests) when, for example, a click event is triggered in response to input from user input devices 20. In some embodiments, the web browser 38 may handle the queries from each web browser 38 simultaneously. For example, the web browser 38 may maintain a thread for each web browser 38 that manages the queries for the respective web browser. In another example, the web browser 38 may utilize asynchronous, event-driven programming techniques, such that queries from the multiple web browsers 38 may be maintained on a single thread. Additionally, the server 36 may implement caches to store and retrieve items that are frequently requested by the web browsers, such as icons, logos, or other visual elements.

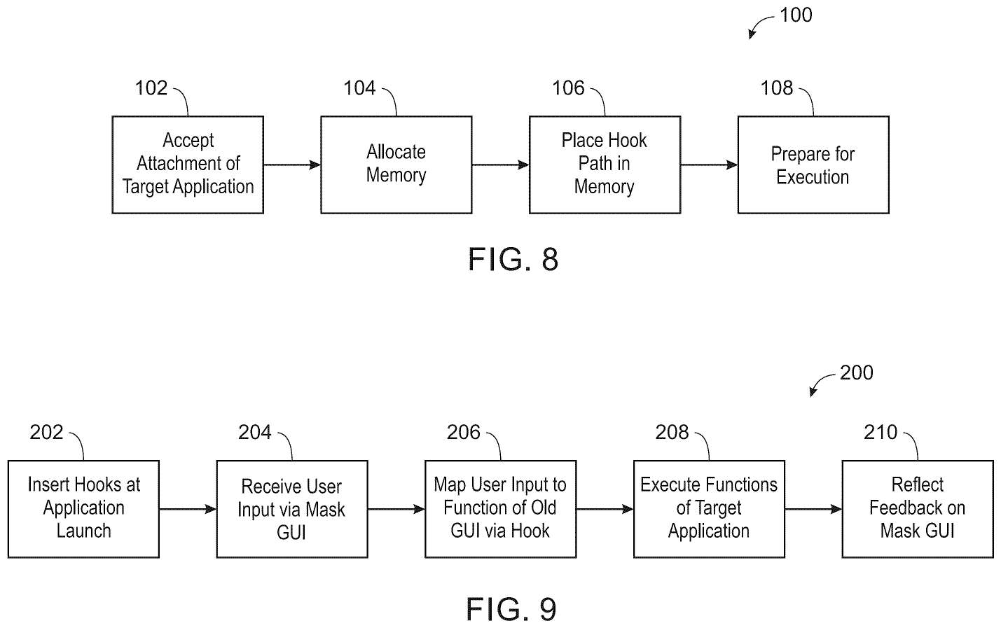

FIG. 8 is a flow chart of an example method 100 for implementing an updated graphical user interface using the techniques described herein, and is discussed with reference to the aforementioned figures. While the method 100 is described as being performed by the web browser 38 and the target application 17, the method 100 may be performed by a thick client, the server 36, or other suitable components of the system 11. The method may begin in block 102 with the target platform/OS 11 attaching the target application 17, along with associated target functions and the target user interface 18, to the web browser 38. Attaching the target application 17 may include, for example, an exchange of access rights between the web browser 38 and the target application 17 necessary to perform the subsequent steps, such as read permissions, write permissions, and the like.

In block 104, the target platform/OS 11 may allocate memory associated with the web browser 38 to store functions, objects, and so on associated with accessing the target application 17. In particular, in block 106, paths associated with the hook 39 may be copied into the allocated memory. The paths may include, for example, paths to various target function of the target application 17, to visual elements of the target user interface 18, and the like. The copied paths may have an associated memory address that may be referenced when a hook is executed. For example, the memory address may be referenced in response to a click event and/or a query to the server 36, as described herein. Once the hook is placed in memory, in block 108, the target platform/OS 11 may prepare the web browser 38 for execution of the hook. Preparations may include modifying executable sources of the target platform/OS 11 or injecting target functions into the runtime processes of the web browser 38. The preparation may also include targeting a thread of the web browser 38, saving current registers of the web browser 38, changing an instruction pointer to the memory address of the copied paths, and/or resuming the thread.

FIG. 9 is a flowchart of a method 200 for launching an updated user interface, hooking to a target application in response to user input, and reflecting feedback on the updated user interface. In block 202, a web browser (e.g., the web browser 38) launches an updated user interface (e.g., updated user interface 19). The web browser 38 may launch the updated user interface 19 in response to user input (e.g. from user input devices 20). For example, the updated user interface 19 may include a web page, and the web page may be launched in response to a user inputting a URL associated with the web page at the web browser 38. Upon launching the updated user interface 19, hooks may be placed in suitable locations in the memory of the web browser 38, such as within initialization loop instructions, within click event instructions, and so on. These hooks may be inserted at a runtime of the target platform/OS 11, the web browser 38, or a thick client associated with the updated user interface 19.

In block 204, the web browser 38 receives an input from, for example, a user via user input devices 20. The input may include a user selecting an HTML element of the updated user interface 19, such as a button, and may cause an associated input event to be executed. The execution of the input event may cause, in block 206, a reference to a location in memory (e.g., of the web browser 38 or the server 36) that includes associated hook paths. The hooks path may, in block 208, cause the execution of corresponding target functions of a target application (e.g., the target application 17). In block 210, the execution of the target functions may cause reflected feedback at the updated user interface 19. The reflected feedback may include changes to visual elements of the updated user interface 19, control indications of a medical device, information updates, and so on.

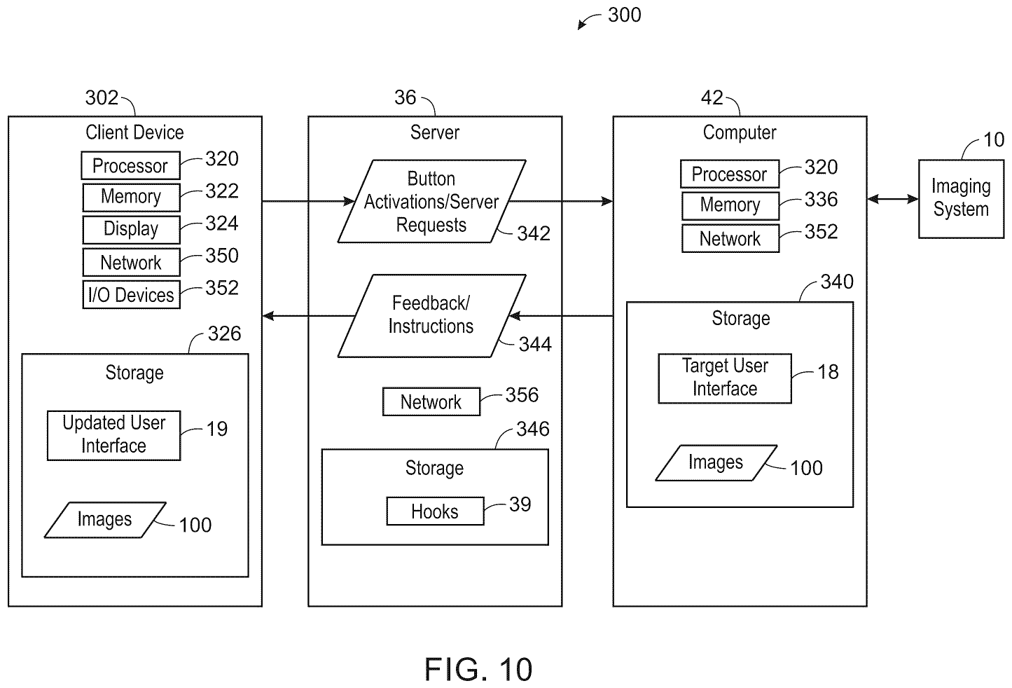

With the preceding in mind, FIG. 10 illustrates an embodiment of client-server architecture 300 for an implementation of an updated graphical user interface in accordance with the presently described techniques. The client-server architecture 300 may be used, for example, to facilitate communications between a client device 302, the server 36, the computer 42, and the imaging system 10. In the depicted example, the client-server architecture 300 generally includes at least one computer 42 and at least one frontend computing system, here represented as a client device 302 that is communicatively coupled, directly or indirectly, via a suitable network 312 (e.g., a local area network (LAN), a wide area network (WAN), virtual private networks (VPN), the internet). The client device 302 may, for example, execute functions associated with the web browser 38 and/or the updated user interface 19, and the computer 42 may execute functions associated with the target application 17 and/or the target user interface 18, such as target functions described herein. The computer 42 may also be communicatively coupled with the imaging system 10, and may store and analyze images 100 received from the imaging system 10. In some embodiments, the cloud-server architecture 300 may include at least one server deployed on a LAN of a medical facility. For embodiments in which the client-server architecture 300 is wholly or partially a cloud-based client-server architecture, the imaging system 10 or the client-server architecture 300 may include one or more rack-mounted servers deployed at a remote data center or locally at a medical facility. The client device 302 may include or may be coupled to a desktop or laptop computer of a clinician, for example, deployed on the LAN of a medical facility or coupled to the computer 42 via a suitable network connection.

In the following description it should be appreciated that certain functionality may be implemented on the computer 42, the frontend computing system (e.g., the client device 302 and/or associated workstation), or both. As such certain routines and/or functionality may be described as possibly being present on both the computer 42 and/or the client device 302 (or associated workstation). In practice, such routines or functionality will likely be implemented on only one of the frontend or backend, as determined based on implementation and business specific decisions. For completeness, however, the present discussion will describe such functionality as potentially being implemented on either the front or back end.

With this in mind, in the depicted example, the computer 42 includes at least one processor 320, at least one memory 336 (e.g., random access memory (RAM), read-only memory (ROM)), at least one networking device 352 (e.g., a wireless networking card, an Ethernet networking card), and at least one storage device 340 (e.g., non-transitory computer readable media, such as, but not limited to, a hard disk device, a solid-state disk device, a flash memory device). The processor 320 may include one or more central processing units (CPUs), each having one or more processing cores configured to execute instructions and process data loaded into the memory 336 from the storage 340. The storage 340 of the computer 42, in the present context, may store images 100 (e.g., medical images or scans), a target application configured to execute one or more target functions associated with a target user interface 18 or control of the imaging system 10, processor-executable GUI routines or frameworks 18 configured to present data of a patient and imaging system, and one or more processor-executable routines for analysis (e.g., multi-planar reconstruction) and presentation of the images 100.

The frontend computing system, here represented as an client device 302 or workstation associated with such an client device, generally includes at least one processor 320, at least one memory 322 (e.g., random access memory (RAM), read-only memory (ROM)), at least one networking device 350 (e.g., a wireless networking card, an Ethernet networking card), and at least one storage 326 (e.g., non-transitory computer readable media, such as, but not limited to, a hard disk device, a solid-state disk device, a flash memory device), and a display 324 that may display graphical components and medical images. Additionally, the client device 302 includes input/output (I/O) devices 352, such as a keyboard, mouse, touchpad, touchscreen, speakers, displays, and so forth, which enable the clinician to provide inputs to, and receive the outputs of, the client device 302. In certain embodiments, the client device 302 includes at least one graphics processing unit (GPU) that is generally configured to perform graphical processing to present images on the display of the client device 302. The storage 326, in the present context, may store images 100 (e.g., medical images or scans), one or more processor-executable GUI routines or frameworks 19 configured to present data of a patient and imaging system, and one or more processor-executable routines for analysis (e.g., multi-planar reconstruction) and presentation of the images 100. The one or more processor-executable GUI routines or frameworks 19 may include routines for updating and displaying a web page facilitated by a web browser, and may query a web server (e.g., the server 36) for updates to the web page.

The server 36, which may include one or more rack-mounted server devices located on-site at a medical facility, may include at least one networking device 356 (e.g., a wireless networking card, an Ethernet networking card), and at least one storage 346 (e.g., non-transitory computer readable media, such as, but not limited to, a hard disk device, a solid-state disk device, a flash memory device). The storage 346, in the present context, may store one or more processor-executable hooks 39 configured to map GUI routines of the updated user interface 19 to GU routines of the target user interface 18. The server 36 may also include a processor, a memory, or other components suitable for networking and executing the hooks 39.

In the depicted example, information is illustrated as being exchanged between the client device 302 and the computer 42 via the server 36. In practice, such data may include, but is not limited to, data associated with an input event detected by the client device, such as button activation indications and server requests, feedback and/or instructions to change one or more elements of the updated graphical user interface 19, instructions associated with a medical imaging system, and the like. By way of example, in a first implementation, user input acquired by the client device 302 (e.g., via the I/O devices 352) may be transmitted to the computer 42 via the server 36, where it may be mapped to one or more user interface routines (e.g., target functions) of the target user interface 18. In one such example, user input received via the I/O devices 352 are determined to correspond to a click event, and the client device 302 sends a button activation server request to the computer 42 via the server 36. The server 36 may map the button activation server request to one or more GUI routines (e.g., target functions) of the target graphical user interface 18. In response, the imaging system 304 may send an output of the one or more GUI routines as feedback/instructions 344 to the client device 302 via the server 36. In the depicted example, one or more of feedback or instructions may be transmitted back to the client device 308, though such data may not be conveyed in all instances.

In another implementation, the frontend, here illustrated as client device 302, may include a thick client architecture, and additional functionality may be performed on the frontend. In this example, user input acquired via the I/O devices 352 or other means may be determined as corresponding to a click event, and the processor 320 may execute mapping routines (e.g., hooks) to map the click event to GUI routines of the target user interface 18. In this example, the client device 302 may also locally store (e.g., in the storage 326) processor-executable routines for locally maintaining and updating a graphical user interface (e.g., the updated graphical user interface 19). As such, a graphical user interface may be maintained without a web page or a web browser, and may be updated without query to a web server. In this example, portions of the communication functionality, such as the exchange of button activations/server requests 342 and feedback/instructions 344 between the client device 302 and the computer 42, may be performed by client device 302 individually or by the client device 302 and the server 36 in conjunction.

As may be appreciated from the preceding examples, aspects of the presently described techniques such as user input acquisition, graphical user interface updates, image processing, and analysis/visualization may be performed at one location or may be distributed between systems, such as between local and cloud-based systems. While the preceding examples relate to certain possible implementation scenarios, it may be appreciated that other practical implementations may be performed and are contemplated by the present disclosure. Further, it may be appreciated that aspects of the preceding examples may be mixed to achieve hybrid implementations, such as where multiple client devices 302 are present having different capabilities (e.g., different graphical user interface elements) and thus may each send different input event information, button activations, server requests, and the like. For example, in certain hybrid scenarios certain client devices 302 may transmit certain button activations or server requests (e.g., associated with certain graphical user interface elements) while other client devices 302 may transmit other button activations or server requests. Thus, the present examples should be understood in view of their intent to provide useful context and implementation scenarios, but not as an exhaustive listing of all possible implementations or permutations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A processor-implemented method comprising:
receiving user input from one or more user input devices, the user input corresponding to a selected element of a displayed graphical user interface having one or more software hooks to functionality provided by an undisplayed interface;
determining one or more corresponding target functions of the undisplayed interface based on the selected element;
executing the one or more corresponding target functions via the one or more software hooks; and
displaying one or more changes to the displayed graphical user interface based on the execution of the one or more corresponding target functions.

2. The processor-implemented method of claim 1, wherein the displayed graphical user interface is stored on a first computing device and displayed by the first computing device, the undisplayed interface is stored on a second computing device, and the one or more software hooks are stored on a server.

3. The processor-implemented method of claim 2, wherein the server is communicatively coupled to the first computing device and the second computing device.

4. The processor-implemented method of claim 2, wherein the second computing device is configured to receive medical imagery from a medical imaging device.

5. The processor-implemented method of claim 1, wherein the displayed graphical user interface is configured to display images acquired by a medical imaging device.

6. The processor-implemented method of claim 1, wherein the displayed graphical user interface comprises layouts, windows, buttons, icons, menus, or a combination thereof.

7. The processor-implemented method of claim 1, wherein the selected element comprises a window, button, image, icon, or menu.

8. The processor-implemented method of claim 1, wherein the one or more corresponding target functions are determined based on a mapping between elements of the displayed graphical user interface and a plurality of target functions of the undisplayed interface.

9. The processor-implemented method of claim 8, wherein the elements of the displayed graphical user interface comprise the selected element, and wherein the plurality of target functions comprises the one or more corresponding target functions.

10. A non-transitory computer-readable medium, the computer-readable medium comprising processor-executable code that when executed by a processor, causes the processor to:
receive user input from one or more user input devices, the user input corresponding to a selected element of a displayed graphical user interface having one or more software hooks to functionality provided by an undisplayed interface;
determine one or more corresponding target functions of the undisplayed interface based on the selected element;
execute the one or more corresponding target functions via the one or more software hooks; and
display one or more changes to the displayed graphical user interface based on the execution of the one or more corresponding target functions.

11. The non-transitory computer-readable medium of claim 10, wherein the selected element comprises a Hypertext Markup Language (HTML) element.

12. The non-transitory computer-readable medium of claim 10, wherein the displayed graphical user interface is part of a first software application, and wherein the undisplayed interface is part of a second software application.

13. The non-transitory computer-readable medium of claim 12, wherein the first software application comprises a web page.

14. The non-transitory computer-readable medium of claim 13, wherein the web page is updated by a web browser.

15. The non-transitory computer-readable medium of claim 12, wherein the first software application and the second software application are managed by a shared operating system.

16. A system, comprising:
a first computing device configured to:
display a graphical user interface;
receive user input from one or more user input devices, the user input corresponding to a selected element of the displayed graphical user interface having one or more software hooks to functionality provided by an undisplayed interface;
transmit an indication of the selected element; and
a second computing device configured to:
receive the indication of the selected element;
determine one or more corresponding target functions of the undisplayed interface based on the selected element;
instruct a third computing device to execute the one or more corresponding target functions via the one or more software hooks;
receive an output associated with the execution of the one or more corresponding target functions; and
instruct the first computing device to change one or more elements of the displayed graphical user interface based on the output.

17. The system of claim 16, wherein the indication of the selected element comprises an input event.

18. The system of claim 16, wherein the second computing device comprises a server.

19. The system of claim 16, wherein the third computing device is configured to receive medical imagery from a medical imaging device.

20. The system of claim 19, wherein the output is associated with control of the medical imaging device, display of the medical imagery, or a combination thereof.
